(19) United States
(12) Patent Application Publication
(10) Pub. No.: US 2006/0273066 A1
(43) Pub. Date: Dec. 7, 2006

(54) Method for manufacturing a magnetic sensor having an ultra-narrow track width

(75) Inventors: Daniel Wayne Bedell, Gilroy, CA (US); Vladimir Nikitin, Campbell, CA (US)

Correspondence Address: ZILKA-KOTAB, PC, P.O. BOX 721120, SAN JOSE, CA, 95172-1120, US

(73) Assignee: HITACHI GLOBAL STORAGE TECHNOLOGIES

(21) Appl. No.: 11/143,902

(22) Filed: Jun. 1, 2005

(51) Int. Cl. B44C 1/22; C23F 1/00; C03C 15/00

(52) U.S. Cl. 216/22; 216/41; 216/57

(57) ABSTRACT

A method for constructing a device such as a magnetoresistive sensor having an extremely narrow width (track width). A photoresist mask is deposited with an edge where an edge of the device is to be located. A layer of material that is susceptible to removal by reactive ion etch (RIEable material) is then deposited over this first mask. The RIEable material is deposited by a conformal deposition method so that it covers the edge of the first mask substantially the same thickness as it covers the other areas. A reactive ion etch (RIE) is then performed to remove horizontally disposed portions of the RIEable layer intact, while leaving at least a portion of the RIEable material at the edge of the sensor intact. This remaining portion of the RIEable material can then be used as a very narrow mask for defining a device such as a magnetoresitive sensor by ion milling.

### FIELD OF THE INVENTION

The present invention relates to a wafer processing technique and more particularly to a method for manufacturing a device, such as a magnetoresistive sensor or other device, having a very narrow width and small width variation.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating but, when the disk rotates, air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic impressions in tracks on the moving media, such as in circular tracks on the aforementioned rotating disk.

In recent read head designs a spin valve sensor, also referred to as a giant magnetoresistive (GMR) sensor, has been employed for sensing magnetic fields from the rotating magnetic disk. The sensor includes a nonmagnetic conductive layer, hereinafter referred to as a spacer layer, sandwiched between first and second ferromagnetic layers, hereinafter referred to as a pinned layer and a free layer. First and second leads are connected to the spin valve sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos Θ, where Θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

When a spin valve sensor employs a single pinned layer it is referred to as a simple spin valve. When a spin valve employs an antiparallel (AP) pinned layer it is referred to as an AP pinned spin valve. An AP spin valve includes first and second magnetic layers separated by a thin non-magnetic coupling layer such as Ru. The thickness of the spacer layer is chosen so as to antiparallel couple the magnetizations of the ferromagnetic layers of the pinned layer. A spin valve is also known as a top or bottom spin valve depending upon whether the pinning layer is at the top (formed after the free layer) or at the bottom (before the free layer).

The spin valve sensor is located between first and second nonmagnetic electrically insulating read gap layers and the first and second read gap layers are located between ferromagnetic first and second shield layers. In a merged magnetic head a single ferromagnetic layer functions as the second shield layer of the read head and as the first pole piece layer of the write head. In a piggyback head the second shield layer and the first pole piece layer are separate layers.

Magnetization of the pinned layer is usually fixed by exchange coupling one of the ferromagnetic layers (AP 1) with a layer of antiferromagnetic material such as PtMn. While an antiferromagnetic (AFM) material such as PtMn does not in and of itself have a magnetization, when exchange coupled with a magnetic material, it can strongly pin the magnetization of the ferromagnetic layer.

The push for ever increased data rate and data capacity results in a need for GMR sensors having ever smaller track width. This smaller track width determines the number of tracks of data that can be fit onto a given magnetic medium. The track width is, however, limited by manufacturing capabilities. For example, the width of magnetoresisive sensor has been limited to a width at which a mask, such as photoresist, can be accurately photolithographically patterned. Optical lithography is running out of the resolution to provide narrow read track width sensors with tight sigma control.

Techniques such as phase shifting masks and E-beam lithography have provided some additional resolution and corresponding decrease in track width, but are expensive and limited to trackwidths of about 50 nm. To appreciate the problem, consider that the sigma of a photolithographic process is about 5 nm. This sigma does not decrease with decreasing track width, so it can be appreciated that trackwidths approaching 5 nm are impractical using such photolithographic techniques.

Therefore, a strong felt need exists for a wafer manufacturing process that can form structures having very small track widths with precise width control. Preferably, such a method would be able to build devices such as magnetoresistive heads having widths less than 10 nm with sigma of about 1 nm. Such a method would also not require the use of expensive tooling such as E-beam lithography tooling or phase shifting masks.

### SUMMARY OF THE INVENTION

The present invention provides a method for constructing a device such as a magnetoresistive sensor having an extremely narrow width and tight distribution (small sigma of the width). A plurality of sensor layers is deposited on a substrate. A first mask, formed of for example photoresist, is formed over the sensor layers. The first mask is formed to cover only a portion of the sensor layers, the first mask terminating at an edge to leave a portion of the sensor layers uncovered. A layer of material that is susceptible to removal by reactive ion etching (RIEable material) is then deposited by a conformal deposition method so that it covers the edge of the first mask as well as the top and on the sides of the first mask and exposed portion of the sensor layers. A reactive ion etch (RIE) is then performed to remove the RIEable material from the top of the first mask and from the uncovered portion of the sensor layers leaving a portion of the RIEable material at the edge of the first mask. The first mask can then be chemically stripped off leaving the remaining RIEable material as a very thin second mask for defining the device (sensor) by a subsequent ion milling operation.

The invention advantageously allows devices such as sensor to be constructed with extremely narrow widths while providing extremely fine control over the width distribution. The invention can advantageously achieve this end, without the need for expensive E-beam lithography or phase shifting photolithographic masks.

The present invention takes advantage of both the directional nature of reactive ion etching and the selectivity of the RIEable material and isotropic deposition. The RIEable material, which can be for example SiO₂, Al₂O₃, SiN₄ or SiOₓN_{y}, W, Ta, has the property that it is removed by RIE much more quickly than the other materials such as the sensor layers. In fact this selectivity ratio is about 50/1.

The invention also takes advantage of the directional nature of RIE. This causes the RIE to remove the horizontally disposed portions of the RIEable material at a much faster rate than the vertically disposed portion formed on the side wall of the first mask. This allows the RIE to leave the vertically disposed portion as a very thin mask while removing the other portions.

Taking advantage of these features (the selectivity of the RIEable material and the directional nature of RIE) allows a very narrow mask to be formed without generating an asymmetry in the underlying sensor layers. Without the advantages of selectivity and directionality, the process of forming the narrow mask would also result in removal of sensor material at only one side of the mask, causing a sever shape asymmetry in the produced sensor device.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIGS. 3 is an ABS view of a mangeotresistive sensor taken from circle 3 of FIG. 2; and

FIGS. 4-13 are views of a sensor in various intermediate stages of manufacture, illustrating a method for constructing a sensor according to the present invention.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

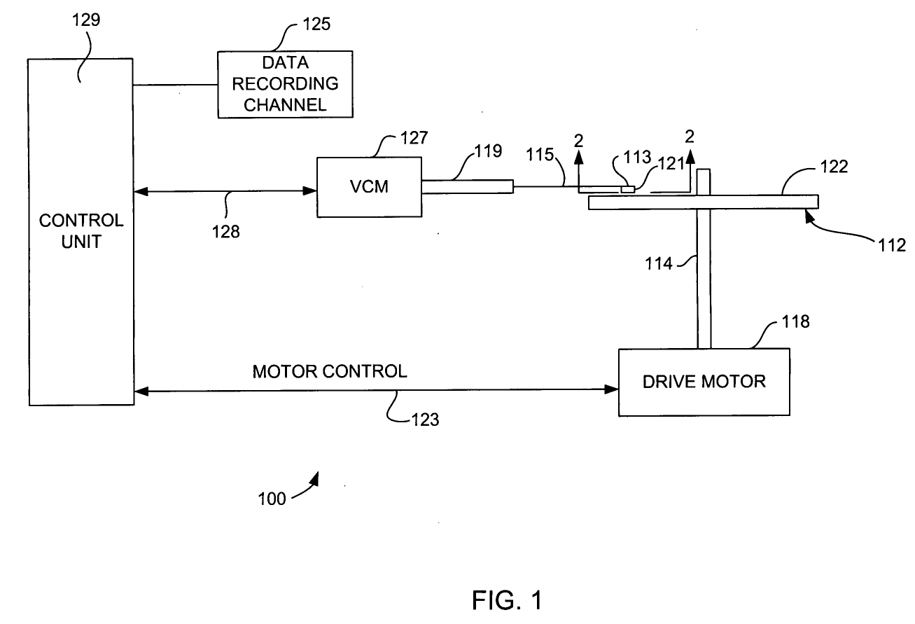

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

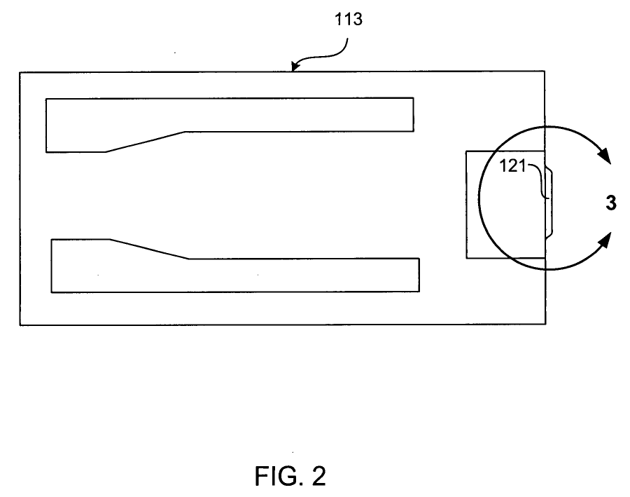

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

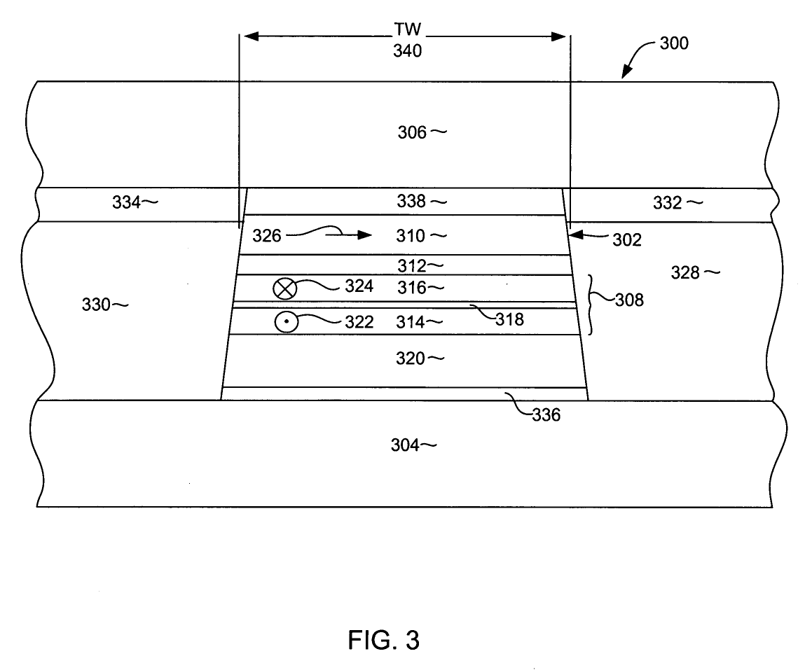

With reference now to FIG. 3, a magnetoresistive sensor 300 includes a sensor stack 302 sandwiched between first and second non-magnetic, electrically insulating gap layers 304, 306. The sensor 300 could be essentially any type of sensor such as a CPP GMR or a tunnel valve, but is described herein as a CIP GMR sensor for purposes of illustration. The sensor stack 302 includes a magnetically pinned layer 308, a magnetic free layer 310 and a non-magnetic, electrically conductive spacer layer 312 sandwiched 5 between the free and pinned layers. The pinned layer 308 can be an AP coupled pinned layer structure having an AP1 layer 314, an AP2 layer 316 and an antiparallel coupling layer 318 sandwiched therebetween. A layer of antiferromagnetic material AFM layer 320 is exchange coupled with the AP1 layer 314, which strongly pins the magnetic moment 322 of the AP1 layer in a desired direction perpendicular to the ABS. Strong antiparallel coupling between the AP1 and AP2 layers causes the AP2 layer to have a magnetic moment 324 that is pinned antiparallel with the moment 322 of the AP1 layer. The AP1, and AP2 layers can be constructed of, for example, CoFe or some other magnetic material. The AP coupling layer 318 can be, for example Ru.

The free layer can be constructed of Co, CoFe, NiFe or some combination of these or other materials. The free layer has a magnetic moment 326 that is biased in a desired direction parallel with the ABS, but that is free to rotate in response to a magnetic field, such as from a magnetic medium. The free layer moment 326 is biased by a first and second hard bias layers 328, 330, constructed of a hard magnetic material such as, for example, CoPtCr. First and second electrically conductive leads 332, 334, formed over the hard bias layers 328, 330 conduct electrical sense current to the sensor stack 302.

The sensor 300 may also include a seed layer 336 formed at the bottom of the sensor stack to promote a desired epitaxial grain growth in the subsequently deposited layers. A capping layer 338, such as Ta, may be provided at the top of the sensor stack 302 to protect the other sensor layers from damage during manufacture. The track width (TW) 340 of the sensor 300 is the width of the sensor stack, and more accurately, is the width of the free layer 312 as viewed from the ABS.

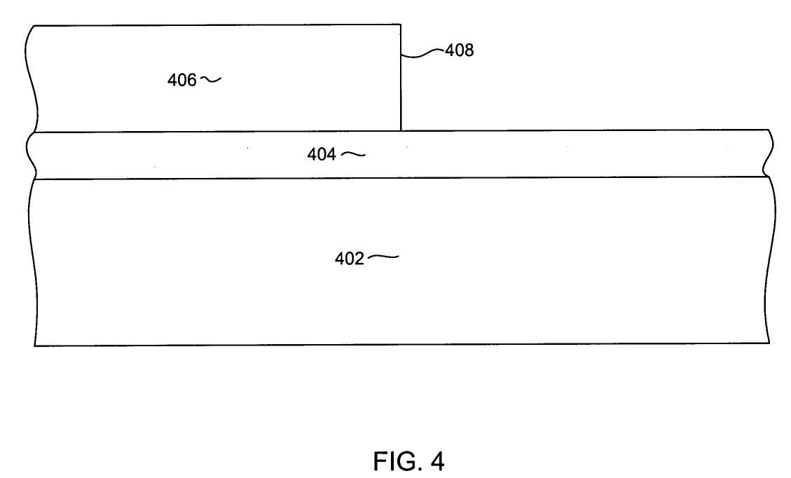

With reference now to FIGS. 4-8, a method of constructing a sensor 300 having a very narrow track width will be described. It should be pointed out that although this method is being described in terms of constructing a magnetoresistive sensor, it could be used in virtually any wafer manufacturing process wherein there is a need to form very narrow structures. Therefore, the process could apply to the construction of, for example, a device in a very large scale integration VLSI, microcircuit formed on a silicon wafer.

With reference now to FIG. 4, a substrate 402 is provided, which can be for example a gap layer 304 (FIG. 3). Then, a layer of material 404 to make up the desired narrow device is deposited over the substrate. In this case the device is a magnetoresistive sensor and the layers 404 are the various layers of the sensor stack 302 (FIG. 3), deposited as full film layers. A layer of mask material 406, such as photoresist is then deposited over the layer 406. The photoresist layer 406 has an edge 408 which is aligned with an edge of the desired device. In the case shown, the right edge 408 positioned to align with a desired left edge of the desired finished sensor stack 302. The photoresist is photolithographically patterned using techniques familiar to those skilled in the art to form a relatively straight vertical edge 408.

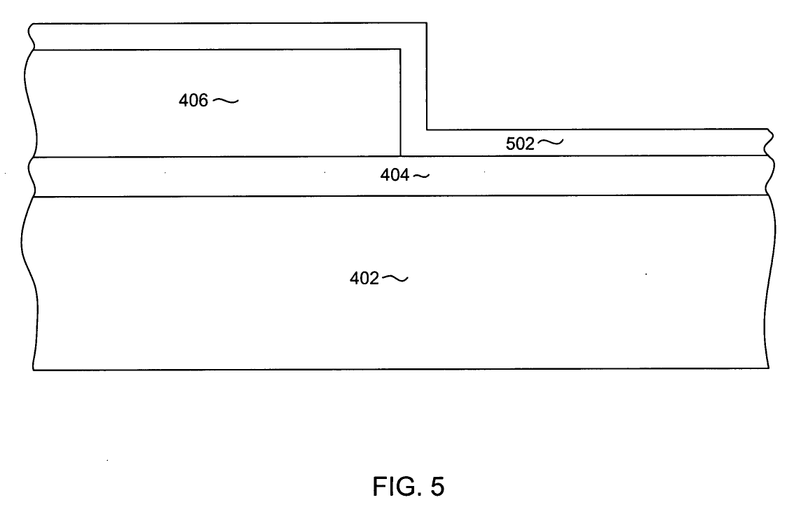

With reference now to FIG. 5, a layer of material 502 that is subsequently selectively removed by a reactive ion etch (RIE) is deposited. In an embodiment of the invention the layer 502 can be, for example SiO₂, Si₃N₄, SiOₓN_{y}, Al₂O₃, W, or Ta. The layer 502 is preferably deposited by conformal deposition process. For example, if the layer 502 is SiO₂ it can be deposited by plasma enhanced chemical vapor deposition (PECVD) or atomic layer deposition (ALD). If the layer 502 is Si₃N₄ or SiOₓN_{y}, it can be applied by PECVD. If the layer 502 is alumina (Al₂O₃) it can be applied for example by ALD. These materials could be also deposited by PVD methods, such as magnetron sputtering deposition or by ion beam deposition.

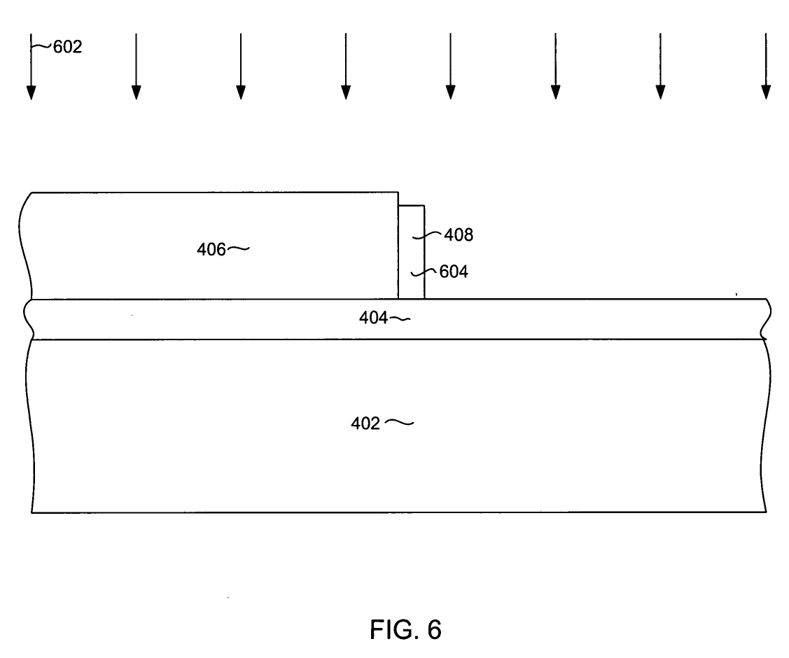

The above described deposition methods of the materials described for layer 502 provide extremely good control of thickness and uniformity. As will be seen below, this is critical in defining and controlling width of the finished device (track width TW 340 of the sensor 300). With reference now to FIG. 6, a reactive ion etch (RIE) is performed to remove horizontally disposed portions of the RIE removable layer 408, leaving a narrow mask 604.

The present invention takes great advantage of (1) the large selective removal rate of the layer 408 as compared with the device layers 404 during the RIE process, and (2) the strongly directional nature of RIE compared with other material removal processes such as ion milling. This allows the horizontal components of the layer 408 to be readily removed, while leaving a vertical portion 408. More importantly this allows the horizontal portions of the layer 408 to be removed while leaving the device layers 404 (sensor layers 302) virtually unaffected by the RIE. As a result, the device layer 404 has the same thickness after RIE on both sides of the narrow mask 604 (ie, same thickness under the photoresist 406 as in the exposed region at the right in FIG. 6). The selectivity of the removal of the layer 408 to the other layers 404 during RIE is about 50/1.

If other non-selectively removed materials were used and if another material removal process other than the RIE process described above were used, the process would not be practical. For example, if the layer 408 were constructed of an electrically conductive material such as Cu, Pt, Pd, Au, Ag, NiFeX, CoZrY, or FeAISi, and removed by, for example an ion milling operation, a large portion of the underlying device layer 404 would be removed from the side not covered by photoresist 406. This would result in an unacceptable asymmetry in the finished device. What's more, the use of ion milling would result in a large amount of material 404 begin redeposited (redep) on the sides of the mask layer 604. This would require the used of a special angled ion mill to removed the redeposited material. Therefore, taking advantage of both the selectivity of the materials described above, along with the directional nature of the RIE process provides an enormous advantage in the present invention.

The RIE 602 results in very negligible redeposition of material. Furthermore, there is only about 1% reduction in thickness of the vertical portion of the layer 408 during the RIE, and this can be predicted and accounted for when depositing the layer 408. What's more the process is scaleable, in that the sigma (variation in thickness of the mask 604) is only about 1.5% of the width of the mask 604 and decreases proportionally with decreased mask thickness. This can be compared with prior art methods described in the Background of the Invention, where the sigma was fixed at about 5 nm so that any significant reduction in device width was completely consumed by the sigma.

If the material layer 408 is constructed of Alumina the RIE can be performed using a Fl or Cl based chemistry (atmosphere in the chamber). Using a Chlorine chemistry gives better selectivity for removing the alumina, but also results in more corrosion of the other layers, whereas a fluorine chemistry results in less corrosion but also less selectivity. If the layer 408 is constructed of one of the other described materials, the RIE can be performed in a fluorine chemistry. In such case, the RIE 602 can be performed in an atmosphere that includes CHF₄, CHF₃, or CF₃.

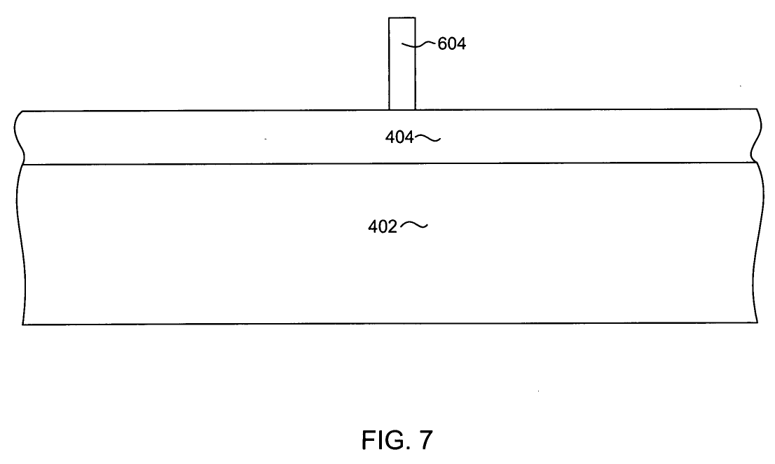

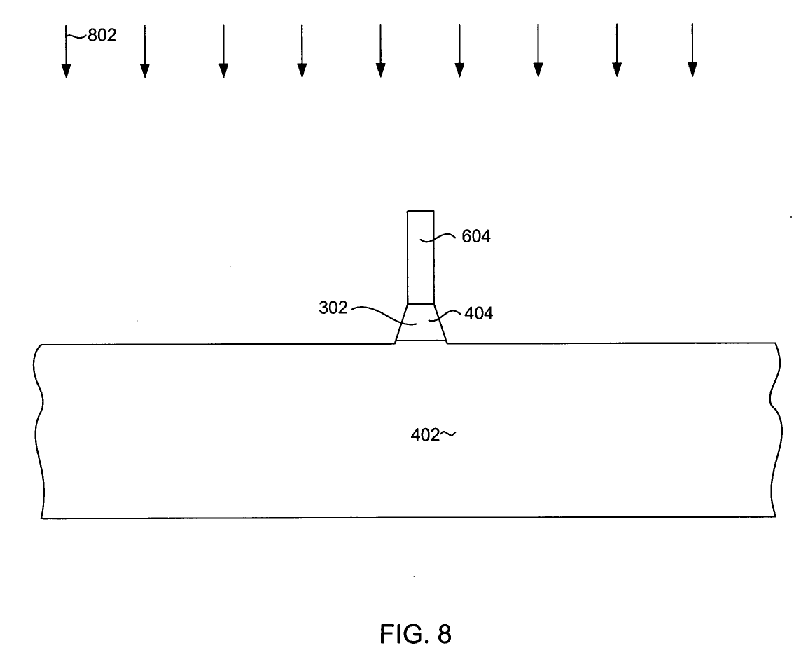

With reference now to FIG. 7, the photoresist layer 406 (FIG. 6) can be removed using a chemical (wet or dry) strip procedure. This leaves the narrow mask 604 intact, and unaffected by the lift off procedure. With reference now to FIG. 8, a material removal process 802 such as ion milling can be used to remove device material 404 (sensor material) not covered by the mask 604. This results in a device (sensor stack 302) that can have a width as small as 10 nm, and typically in the range of 10-100 nm. Because the narrow mask 604 is not readily removed by the ion milling operation, the mask 604 can be construct to have a small height if desired, resulting in less shadowing during the ion mill process. Constructing the mask 604 to have a small height also facilitates the photolithographic patterning of the photoresist 406 by allowing a thinner photoresist layer 406 to be used.

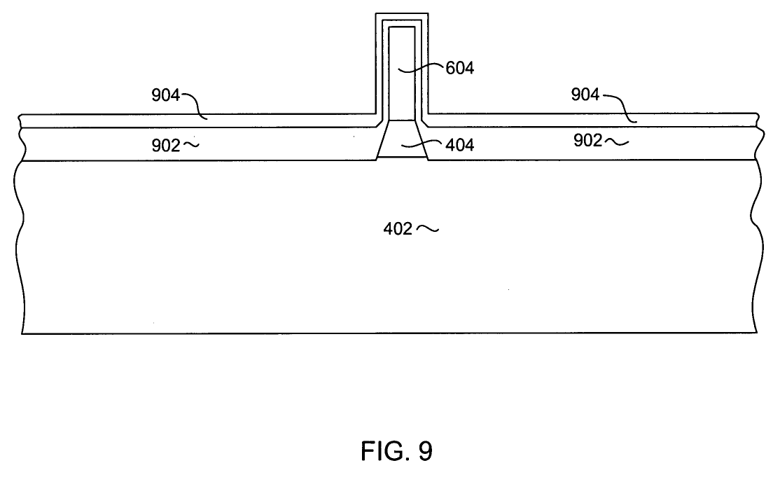

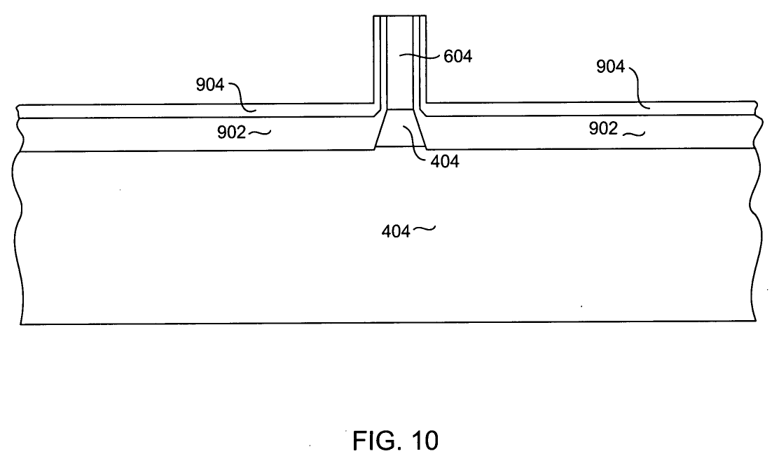

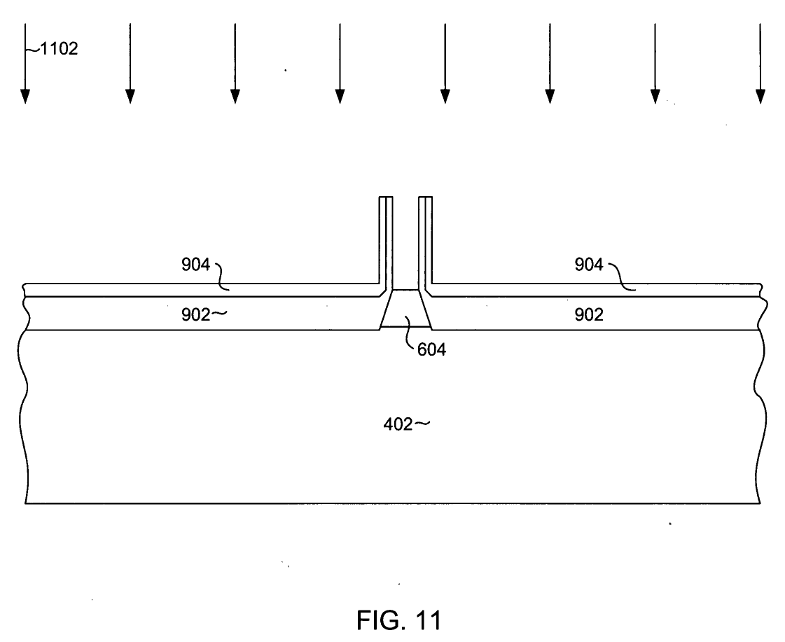

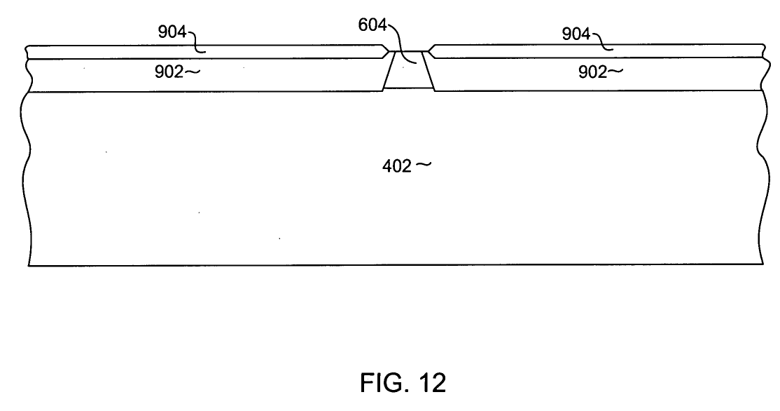

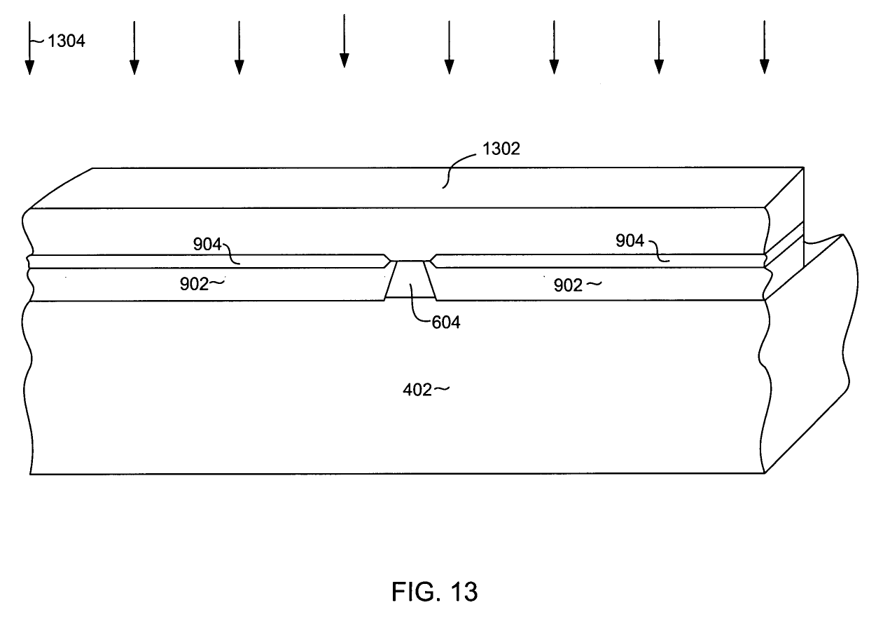

With reference now to FIG. 9, a hard bias layer 902 and an electrically conductive lead layer 904 can be deposited. The hard bias layer 902 can be, for example, CoPtCr and the lead can be an electrically conductive material such as Au, Cu or Rh. With reference to FIG. 10, a light chemical mechanical polishing (CMP) process can be performed to expose a portion of the mask layer 604. Then, with reference to FIG. 11, a reactive ion etch (RIE) 1102 can be performed to remove the narrow mask 604. Because of the preferential selectivity of the RIE for removing the mask material 604, the other structures will be unaffected by the RIE. With reference now to FIG. 12, another CMP can be performed to remove the upward extending remnant portions of the hard bias and lead material 902, 904, planarizing the surfaces. Then, with reference to FIG. 13, back stripe height defining photoresist mask 1302 can be performed and an ion mill 1304 can be performed to define the back edge (stripe height) of the sensor 302. This is followed by the standard gap deposition and formation of the magnetic shield above the sensor.

While various embodiments have been described above, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A method for constructing a device on a wafer, comprising:
depositing at least one layer of device material;
forming a first mask on the device material;
conformally depositing a layer of material that is susceptible to removal by reactive ion etching (RIEable layer);
performing a reactive ion etch (RIE) sufficiently to leave a portion of the RIEable layer as a second mask;
lifting off the first mask; and
performing an ion mill, to remove device material not covered by the second mask.

2. A method as in claim 1, wherein:
the first mask covers a portion of the device material layer, leaving a portion of the device material uncovered,
the first mask has an edge;
the RIEable material layer has horizontally extending portions formed over the first mask layer and the uncovered portion of the device material, and has a vertical portion formed on the edge of the first mask layer; and
the RIE is performed sufficiently to remove substantially all of the horizontally disposed portions of the RIEable material layer while leaving at least a portion of the vertical portion of the RIEable material layer remaining.

3. A method as in claim 1, wherein the first mask layer is a photoresist mask.

4. A method as in claim 1, wherein the RIEable mateterial layer comprises a material selected from the group consisting of SiO₂, Al₂O₃, Si₃N₄ and SiOₓN_{y}.

5. A method as in claim 1, wherein the RIE is performed using a fluorine chemistry.

6. A method as in claim 1, wherein the RIE is performed using a chlorine chemistry.

7. A method as in 1 wherein the first mask is a photoresist mask and where the first mask is lifted off by a chemical process that leaves the remaining RIEable material layer intact.

8. A method as in claim 1, further comprising performing a second reactive ion etch to remove the remaining RIEable material (second mask layer).

9. A method as in claim 1, wherein the RIEable material is deposited by chemical vapor deposition.

10. A method as in claim 1, wherein the RIEable material is deposited by plasma enhanced chemical vapor deposition.

11. A method as in claim 1, wherein the RIEable material is deposited by atomic layer deposition.

12. A method for manufacturing a magnetoresistive sensor, comprising:
providing a substrate;
depositing a plurality of sensor layers over the substrate;
forming a first mask over a portion of the plurality of sensor layers, leaving a portion of the sensor layers uncovered;
depositing a layer of material that is susceptible to removal by reactive ion etching (RIEable layer), the RIEable layer being conformally deposited;
performing a reactive ion etch to remove a portion of the RIEable layer, leaving a portion of the RIEable layer as a second mask;
lifting off the first mask; and
performing an ion mill to remove at least a portion of the sensor layers that are not covered by the second mask.

13. A method as in claim 12, wherein:
the first mask has a top surface and an edge;
the RIEable material layer, as deposited, extends over the top surface first mask, the edge of the first mask and the uncovered portion of the sensor layers, and wherein the RIE is performed sufficiently to remove substantially all of the RIEable material formed over the top surface of the first mask and the uncovered portion of the sensor layers, leaving RIEable material remaining on the edge of the first mask.

14. A method as in claim 12, wherein the first mask is a photoresist mask.

15. A method as in claim 12, wherein the RIEable material comprises a material selected from the group consisting of SiO₂, Al₂O₃, Si₃N₄ and SiOₓN_{y}.

16. A method as in claim 12, wherein the RIE is performed in a fluorine chemistry.

17. A method as in claim 12, wherein the RIE is performed in an oxygen chemistry.

18. A method as in claim 12, wherein the RIEable material is deposited by chemical vapor deposition.

19. A method as in claim 12, wherein the RIEable material is deposited by plasma enhanced chemical vapor deposition.

20. A method as in claim 12, wherein the RIEable material is deposited by atomic layer deposition.

21. A method as in claim 12, further comprising after performing the ion mill to remove a portion of the sensor layers:
depositing a layer of hard magnetic material;
depositing a layer of electrically conductive lead material;
performing a chemical mechanical polish; and
performing a second reactive ion etch to remove the remaining RIEable material.
